(19) United States
(12) Patent Application Publication
(10) Pub. No.: US 2010/0301504 A1
(43) Pub. Date: Dec. 2, 2010

(54) METHOD OF MAKING LIGHT-GUIDING MODULE

(75) Inventors: Cheng-Yang Hsieh, Taichung (TW); Chih-Kung Huang, Hsinchu City (TW); Wei-Jen Lai, Hsinchu County (TW)

Correspondence Address: Muncy, Geissler, Olds & Lowe, PLLC, 4000 Legato Road, Suite 310, FAIRFAX, VA, 22033, US

(73) Assignee: IBIS INNOTECH INC.

(21) Appl. No.: 12/471,888

(22) Filed: May 26, 2009

(51) Int. Cl. B29D 11/00; B05D 5/06

(52) U.S. Cl. 264/1.29; 427/162; 264/1.24

(57) ABSTRACT

A method of making a light-guiding module includes the steps of applying a layer of light guide material containing methyl methacrylate oligomers on a reflector, and polymerizing the methyl methacrylate oligomers of the light guide material at a temperature ranging from 60 to 65° C. for 2.5 to 3 hours to form a light guide plate containing polymethylmethacrylate and integrally combining the reflector. Since there is no any gap between the light guide plate and the reflector, the light-guiding module reduces light loss, and improves the luminous efficiency of the backlight unit in which the light-guiding module is used.

### BACKGROUND OF THE INVENTION

1. Field of the Invention

The present invention relates to light-guiding modules and more particularly, to a method of making a light-guiding module, which enables a reflector and a light guide plate to be made integrally.

2. Description of the Related Art

A backlight unit for a liquid crystal display (hereinafter referred to as “LCD”) generally comprises a light source, a light guide plate, a reflector, a diffuser, a brightness enhancement film and a polarization converter. The light guide plate is adapted for guiding the direction of incident light, enhancing the luminance of the liquid crystal panel and controlling the brightness distribution uniformly. The reflector is adapted for avoiding leakage of light through the bottom side of the light guide plate, enhancing the efficiency of use of incident light. The diffuser is adapted for diffusing the light passing through the light guide plate to a uniform surface light.

A conventional backlight unit has the aforesaid component parts assembled together in proper order. Because a gap is inevitably left between each two adjacent component parts, a part of the light going from one component part to another will be reflected or refracted, lowering the luminous efficiency of the backlight unit. More particularly, the diffusion structure at the bottom side of the light guide plate makes the bottom side of the light guide plate uneven, resulting in a big gap between the light guide plate and the reflector and worsening light loss problem.

Therefore, it is desirable to provide a light-guiding module for backlight unit, which can avoid significant light loss and improve the luminous efficiency of the backlight unit.

### SUMMARY OF THE INVENTION

The present invention has been accomplished in view of the above-noted circumstances. It is an objective of the present invention to provide a method of making a light-guiding module, which enables a light guide plate and a reflector to be made integrally so that the light-guiding module made therefrom can have a low light loss so as to improve the luminous efficiency of the backlight unit in which the light-guiding module is used.

To achieve this objective of the present invention, a method of making a light-guiding module includes the steps of: (a) applying a layer of light guide material containing methyl methacrylate oligomers on a reflector; and (b) polymerizing the methyl methacrylate oligomers of the light guide material at a temperature ranging from 55° C. to 70° C. to form a light guide plate containing polymethylmethacrylate and integrally combining the reflector.

In step (a), the light guide material may contain a plurality of diffusing particles having an average particle size ranging from 0.1 μm to 100 μm. Preferably, the average particle size of said diffusing particles ranges from 1 μm to 10 μm.

In step (a), the reflector may be prepared from polymethylmethacrylate.

In step (a), the reflector may contain a plurality of reflecting particles selected from the group consisting of titanium dioxide particles, mica particles and a mixture thereof.

Preferably, the step (b) may be performed for at least 2 hours.

In step (b), the temperature may preferably be in a range of 60° C. to 65° C.

Preferably, the method of the present invention may further comprise a step of (c) polymerizing the polymethylmethacrylate at a temperature ranging from 115° C. to 130° C. after step (b).

Preferably, the step (c) may be performed for at least one hour.

In step (a), the light guide material may be applied on the reflector by casting, injection molding or extrusion molding.

### BRIEF DESCRIPTION OF THE DRAWINGS

FIG. 1 is a schematic drawing showing step (a) of the method of making a light-guiding module in accordance with a preferred embodiment of the present invention.

FIG. 2 is a schematic drawing showing step (b) of the method of making a light-guiding module in accordance with the present invention.

FIG. 3 is a perspective view of a light-guiding module made according to the method of present invention.

### DETAILED DESCRIPTION OF THE INVENTION

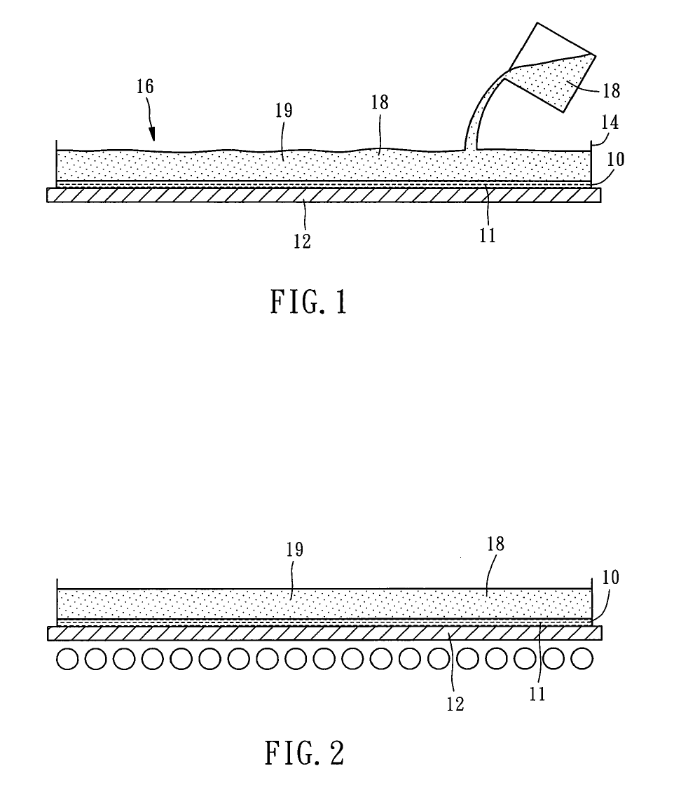

Referring to FIGS. 1-3, a method of making a light-guiding module in accordance with the preferred embodiment of the present invention includes the steps of (a) applying a layer of light guide material containing methyl methacrylate oligomers on a reflector; and (b) polymerizing the methyl methacrylate oligomers of the light guide material at a temperature ranging from 55° C. to 70° C. to form a light guide plate containing polymethylmethacrylate and integrally combining the reflector.

In step (a), as shown in FIG. 1, a reflector 10 is provided and put on a platform 12, and then molding boards 14 are placed around the border of the reflector 10 to define a molding cavity 16 on the top side of the reflector 10, and then a light guide material 18 is poured into the molding cavity 16 to form a layer of the light guide material 18 on the top surface of the reflector 10. As for the light guide material, methyl methacrylate oligomers containing diffusing particles 19 can be used. The diffusing particles 19 may have an average particle size of 0.1 μm to 100 μm, preferably in a range of 1 μm to 10 μm, and may be used in an amount of 1 wt % of the total amount of the light guide material 18 used. As for the reflector 10, it may be prepared from polymethylmethacrylate (PMMA) containing light reflecting particles 11. As for the light reflecting particles 11, titanium dioxide particles or mica particles may be used. Preferably, a mixture of titanium dioxide particles and mica particles may be used as the light reflecting particles 11. By means of the use of the light reflecting particles 11, the reflector 10 can reflect light.

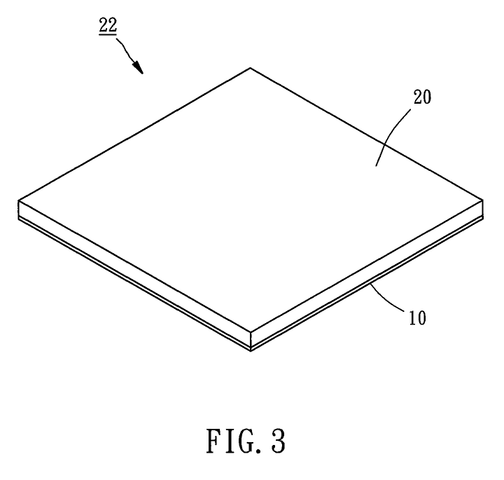

In step (b), as shown in FIG. 2, the light guide material 18 coated reflector 10 is stood for at least 2 hours, preferably for 2.5 to 3 hours, at a temperature of 55° C. to 70° C., preferably at a temperature of 60° C. to 65° C., to have the methyl methacrylate oligomers of the light guide material 18 be polymerized into polymethylmethacrylate (PMMA) and cured. Because the light guide material 18 and the reflector 10 both contain polymethylmethacrylate (PMMA), the light guide plate 20 thus formed after curing of the light guide material 18 is integrally combined with the top surface of the reflector 10, thereby forming a light-guiding module 22, as shown in FIG. 3. Because the light guide plate 20 contains diffusing particles 19 therein, lateral incident light will be uniformly diffused, forming a uniform surface light source on the top side of the light guide plate 20. Therefore, the light guide plate 20 provides an excellent light diffusion function without any extra conventional diffusion structure, i.e., the junction between the light guide plate 20 and the reflector 10 is a flat surface, minimizing light loss.

A step (c) of further polymerizing the polymethylmethacrylate (PMMA) in the light guide plate 20 (or even in the reflector 10) at a temperature of about 115° C. to 130° C., preferably 120° C. to 125° C., for at least one hour, preferably 1-2 hours, can be carried out after the step (b) so as to enhance the structural strength of the light-guiding plate 20 and the bonding strength between the light guide plate 20 and the reflector 10.

Since there is no any gap between the light guide plate 20 and the reflector 10, the invention effectively eliminates the light loss problem of conventional designs. Therefore, the light-guiding module 22 of the present invention effectively improves the luminous efficiency of the backlight unit. Further, because the light guide plate 20 and the reflector 10 are integrally made as a unit, the invention greatly simplifies the manufacturing procedure, shortens the manufacturing time and lowers the manufacturing cost, thereby enhancing product marketability.

It is to be understood that the above-mentioned preferred embodiment is given by way of illustration only, and thus is not limitative of the present invention. For example, in step (a), the light guide material 18 is applied on the top surface of the reflector 10 by casting; however, injection molding or extrusion molding may be used. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of making a light-guiding module comprising the steps of:
(a) applying a layer of light guide material containing methyl methacrylate oligomers on a reflector; and
(b) polymerizing the methyl methacrylate oligomers of the light guide material at a temperature ranging from 55° C. to 70° C. to form a light guide plate containing polymethylmethacrylate and integrally combining the reflector.

2. The method as claimed in claim 1, wherein said light guide material contains a plurality of diffusing particles having an average particle size ranging from 0.1 μm to 100 μm.

3. The method as claimed in claim 2, wherein the average particle size of said diffusing particles ranges from 1 μm to 10 μm.

4. The method as claimed in claim 1, wherein said reflector is prepared from polymethylmethacrylate.

5. The method as claimed in claim 4, wherein said reflector contains a plurality of reflecting particles selected from the group consisting of titanium dioxide particles, mica particles and a mixture thereof.

6. The method as claimed in claim 1, wherein the step (b) is performed for at least 2 hours.

7. The method as claimed in claim 1, wherein the temperature is in a range of 60° C. to 65° C. in step (b).

8. The method as claimed in claim 1, further comprising a step of (c) polymerizing the polymethylmethacrylate at a temperature ranging from 115° C. to 130° C. after step (b).

9. The method as claimed in claim 8, wherein the step (c) is performed for at least one hour.

10. The method as claimed in claim 1, wherein said light guide material is applied on said reflector by means of one of casting, injection molding and extrusion molding.
